(19) United States
(12) Patent Application Publication
(10) Pub. No.: US 2002/0027406 A1
(43) Pub. Date: Mar. 7, 2002

(54) Bi-potential mask type cathode ray tube

(76) Inventors: Tae-Sik Oh, Suwon-city (KR); Byoung-Min Chun, Suwon-city (KR)

Correspondence Address: STAAS & HALSEY LLP, 700 11TH STREET, NW, SUITE 500, WASHINGTON, DC, 20001, US

(21) Appl. No.: 09/939,712

(22) Filed: Aug. 28, 2001

(30) Foreign Application Priority Data
Sep. 5, 2000 (KR) 2000-52518
Sep. 27, 2000 (KR) 2000-56788

(51) Int. Cl. H01J 29/80

(52) U.S. Cl. 313/402

(57) ABSTRACT

A bi-potential mask type cathode ray tube includes a vacuum tube formed by integrally sealing a face panel, a funnel and a neck, a phosphor screen formed on an inner surface of the face panel, a plurality of stud pins mounted on an inner surface of a skirt portion of the face panel, while not contacting a metal film, a shadow mask fixed to the stud pins by a mask frame and coupling springs, first and second anode buttons separately mounted on the funnel, a first conductive layer formed on an inner surface of the funnel while covering the first anode button, a second conductive layer formed on the inner surface of the funnel while covering the second anode button, a first conductive member interconnecting the first conductive layer and the metal film for applying a screen voltage to the phosphor screen, and a second conductive member interconnecting the second conductive layer and the mask frame for applying a mask voltage to the shadow mask.

### CROSS REFERENCE TO RELATED APPLICATION

This application claims the benefit of Korean Application Nos. 2000-52518 and 2000-56788 filed on Sep. 5 and Sep. 27, 2000, respectively, in the Korean Patent Office, the disclosures of which are incorporated herein by reference.

### BACKGROUND OF THE INVENTION

1. Field of the Invention

The present invention relates to a bi-potential mask type cathode ray tube, and more particularly, to a bi-potential mask type cathode ray tube that stably supplies a screen voltage and a mask voltage to a phosphor screen and a shadow mask, respectively, while maintaining an insulation between the phosphor screen and the shadow mask.

2. Description of the Related Art

A cathode ray tube (CRT) is a display device in which electron beams emitted from an electron gun excite phosphors on a phosphor screen such that they emit light, thereby realizing various images. That is, after three rays of electron beams are emitted from the electron gun, they are horizontally and vertically deflected by magnetic fields generated by a deflection yoke, and divided onto corresponding red R, green G and blue B phosphor layers, respectively, through a shadow mask functioning as a color selection electrode. Thus, the electron beams strike all pixels on the phosphor screen, thereby realizing definite color images.

In such a CRT, an identical high voltage is applied to the phosphor screen and the shadow mask, which are electrically interconnected, through an anode button and a graphite layer coated on the inner surface of a funnel. Accordingly, electron beams emitted from the electron gun are accelerated toward the phosphor screen by the high voltage.

In addition to the above CRT, a bi-potential mask type CRT has been proposed. In such a bi-potential mask type CRT, the phosphor screen and the shadow mask are insulated, and a voltage higher than that applied to the shadow mask is applied to the phosphor screen to form an electric field for accelerating electron beams between the shadow mask and the phosphor screen.

The shadow mask is provided with a plurality of beam-passing apertures each functioning as an electrical lens for converging and deflecting the electron beams passing therethrough. The convergence of the electron beams improves the brightness of the screen. Also, the deflection of the electron beams enables the depth of the CRT to be decreased and allows for a decrease in the voltage in the funnel so that a deflection voltage applied to the deflection yoke can be minimized.

However, in the bi-potential mask type CRT, the phosphor screen and shadow mask must be carefully insulated, and different potentials must be stably applied to these elements. Significant technical difficulties are encountered in satisfying these requirements.

### SUMMARY OF THE INVENTION

It is an object of the present invention to provide a bi-potential mask type cathode ray tube that can stably supply a screen voltage and a mask voltage to a phosphor screen and a shadow mask, respectively, while maintaining the insulation between the phosphor screen and the shadow mask.

Additional objects and advantages of the invention will be set forth in part in the description which follows, and, in part, will be obvious form the description, or may be learned by practice of the invention.

To achieve the above and other objects, the present invention provides a bi-potential mask type cathode ray tube comprising a vacuum tube formed by integrally sealing a face panel, a funnel and a neck, a phosphor screen formed on an inner surface of the face panel and having a metal film, a plurality of stud pins mounted on an inner surface of a skirt portion of the face panel, which do not contact the metal film, a shadow mask fixed to the stud pins by a mask frame and coupling springs, first and second anode buttons separately mounted on the funnel, a first conductive layer formed on an inner surface of the funnel while covering the first anode button, a second conductive layer formed on the inner surface of the funnel and covering the second anode button, a first conductive member having a first end contacting the first conductive layer and a second end contacting the metal film for applying a screen voltage to the phosphor screen, the first conductive member being mounted to one of the stud pins while being insulated from the stud pin, and a second conductive member having a first end fixed on the mask frame and a second end contacting the second conductive layer, to apply a mask voltage to the shadow mask.

According to an embodiment of the present invention, the first conductive member comprises an insulating fixing member fixedly inserted around the one stud pin, and a conductive connecting member mounted on the insulating fixing member through a coupling hole formed on the conductive connecting member, the conductive connecting member having a plurality of contact springs for electrically interconnecting the metal film and the first conductive layer.

Preferably, a height of the first conductive member in an uninstalled state is greater than a distance from one end of one of the coupling springs, which faces the one stud pin, to an inner surface of the skirt portion so as to bias the plurality of contact springs against the metal film and the first conductive layer.

The insulating fixing member has an outer circumference with a male thread and the conductive connecting member has a coupling hole with a female thread screw-coupled to the male thread of the insulating fixing member.

Alternatively, the insulating fixing member may comprise an upper portion proximal to the one stud pin and a lower portion proximal to one of the coupling springs, a diameter of the upper portion being less than that of the lower portion. The upper portion of the insulating fixing member has an outer circumference with at least one fixing projection, and the conductive connecting member has a coupling hole corresponding to the upper portion of the insulating fixing member.

Each of the upper and lower portions of the insulating fixing member has a circular cross-section.

Alternatively, the upper portion of the insulating fixing member may have a circular cross-section and the lower portion of the insulating fixing member may have a square cross-section.

Alternatively, each of the upper and lower portions of the insulating fixing member have a square cross-section.

According to another embodiment of the present invention, the first conductive member comprises a coupling hole, a packing insulating member mounted on an inner circumference of the coupling hole so as to insilate the first conductive member from the one stud pin, and a plurality of contact springs electrically connecting the metal film to the first conductive layer.

The first conductive layer may be formed in a strip-shape having a predetermined width and covered by an insulating layer except for a portion contacting the first conductive member. A second conductive layer may be widely deposited on the inner surface of the funnel while covering a portion of the insulating portion except for a portion where the first conductive layer contacts the first conductive member.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a sectional view of a bi-potential mask type CRT according to an embodiment of the present invention;

FIG. 2 is a partial enlarged view illustrating a phosphor screen of the bi-potential mask type CRT shown in FIG. 1;

FIG. 3 is a schematic view illustrating a voltage application path to the phosphor screen shown in FIGS. 1 and 2;

FIG. 4 is an exploded perspective view illustrating a first conductive member and a stud pin of the bi-potential mask type CRT shown in FIG. 1;

FIG. 5 is a side view of the first conductive member shown in FIG. 4;

FIG. 6 is an enlarged view of a circled portion A of FIG. 1;

FIG. 7 is an enlarged view of a circled portion B of FIG. 1;

FIGS. 8 to 12 are exploded perspective views of a first conductive member according to various embodiments of the present invention;

FIG. 13 is a sectional view illustrating a tube of a bi-potential mask type CRT according to another embodiment of the present invention; and

FIG. 14 is a partial sectional view of a major part of the tube shown in FIG. 13.

### DETAILED DESCRIPTION OF THE PREFERRED EMBODIMENTS

Reference will now be made in detail to the present embodiments of the present invention, examples of which are illustrated in the accompanying drawings, wherein like reference numerals refer to like elements throughout.

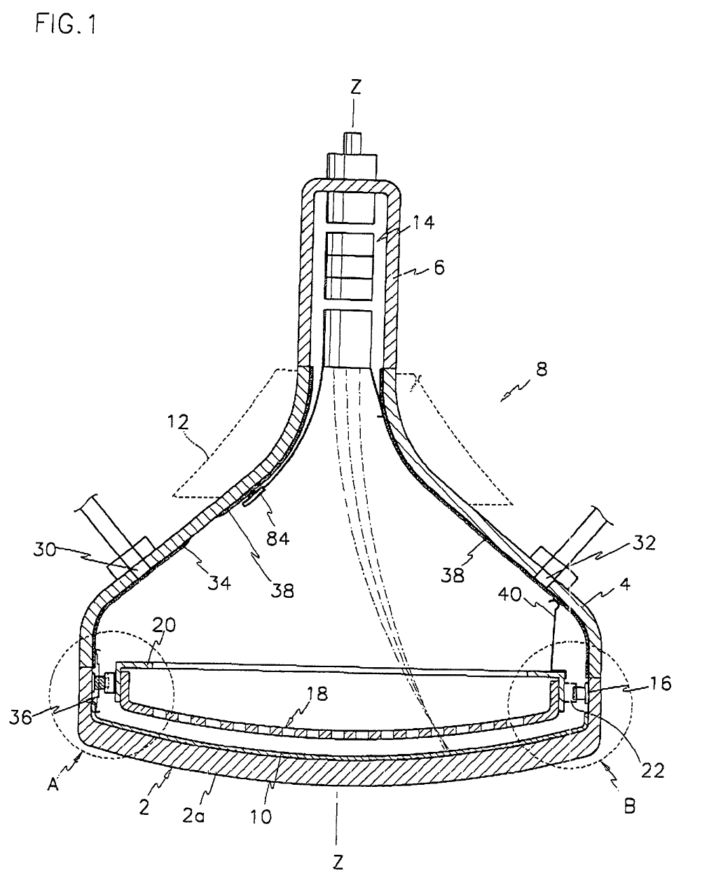

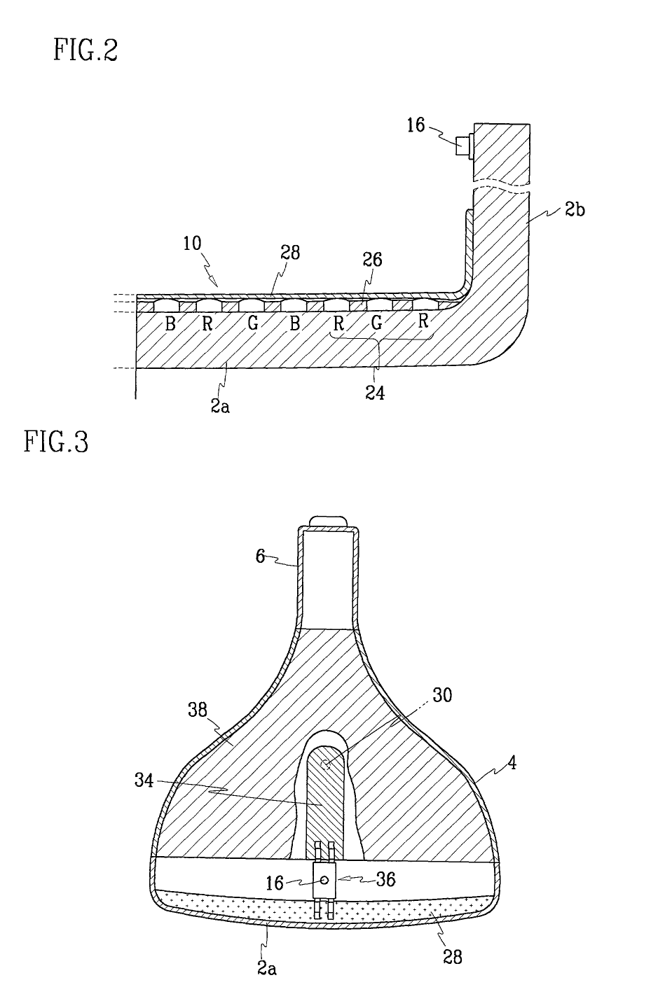

FIGS. 1 and 2 show a bi-potential mask type cathode ray tube (CRT) according to an embodiment of the present invention.

Referring first to FIG. 1, a face panel 2, a funnel 4 and a neck 6 are sealed to define a vacuum tube 8. A phosphor screen 10 is formed on an inner surface of the face panel 2, an electron gun 14 is mounted in the neck 6, and a deflection yoke 12 is mounted around an outer surface of the funnel 4.

As shown in FIG. 2, the face panel 2 comprises an effective area 2a on which the phosphor screen 10 is formed, and a skirt portion 2b extending rearward from the edge of the effective area 2a. A plurality of stud pins 16 are buried in the skirt portion 2b.

A shadow mask 18 functioning as a color selection electrode is suspended on a mask frame 20 at a predetermined distance from the phosphor screen 10 of the face panel 2. That is, a plurality of coupling springs 22 are mounted on the mask frame 20 and detachably coupled on the stud pins 16 (a plurality of these elements are provided but only a single pair appears in the drawing).

The phosphor screen 10 comprises red R, green G and blue B phosphors 24 and a black matrix layer 26 disposed between the phosphors 24. A metal film 28, such as an aluminum evaporation layer, is formed on the phosphors 24 to improve the brightness using a metal back effect.

When such a phosphor screen 10 maintains a high potential by a conductive characteristic of the metal film 28, since the stud pins 16 share a mask voltage with the shadow mask 18, the metal film 28 is formed at a predetermined distance form the stud pins 16 so as to prevent the phosphor screen 10 and the shadow mask 18 from being electrically interconnected.

As described above, the phosphor screen 10 and the shadow mask 18 are insulated from each other in the inside of the face panel 2. Screen and mask voltages are respectively applied to the phosphor screen 10 and the shadow mask 18 through corresponding conductive members provided according to the present invention. That is, first and second anode buttons 30 and 32 for respectively applying the screen and mask voltages to the phosphor screen 10 and the shadow mask 18 are separately installed on the funnel 4.

FIG. 3 shows a schematic view illustrating a voltage application path to the phosphor screen 10.

As shown in the drawing, a first conductive layer 34 is deposited on an inner surface of the funnel 4 while covering the first anode button 30. A first conductive member 36 is mounted on one of the stud pins 16 while being insulated from the stud pin 16. The first conductive member 36 has a first end electrically contacting the first conductive layer 34 and a second end electrically contacting the metal film 28, thereby electrically interconnecting the first conductive layer 34 and the metal film 28.

It is preferable that the first conductive layer 34 is formed in a strip-shape having a uniform width and extending in a direction of a tube-axis (a Z-axis in the drawing). The first conductive layer 34 transmits the screen voltage supplied to the first anode button 30 to the first conductive member 36.

The voltage application structure to the shadow mask 18 will be described with reference to FIG. 1.

A second conductive layer 38 is formed on the inner surface of the funnel 4 while covering the second anode button 32. A second conductive member 40 has a first end fixed on the mask frame 20 and a second end contacting the second conductive layer 38.

Accordingly, the second conductive layer 38 connected to the second anode button 32 shares a mask voltage with the second conductive member 40, the mask frame 20 and the shadow mask 18. Such a mask voltage is also shared with the coupling springs 22 supporting the mask frame 20 and the stud pins 16.

Although the first conductive layer 34 is spaced away from the second conductive layer 38, an insulating layer may be preferably further provided between them to ensure the insulation.

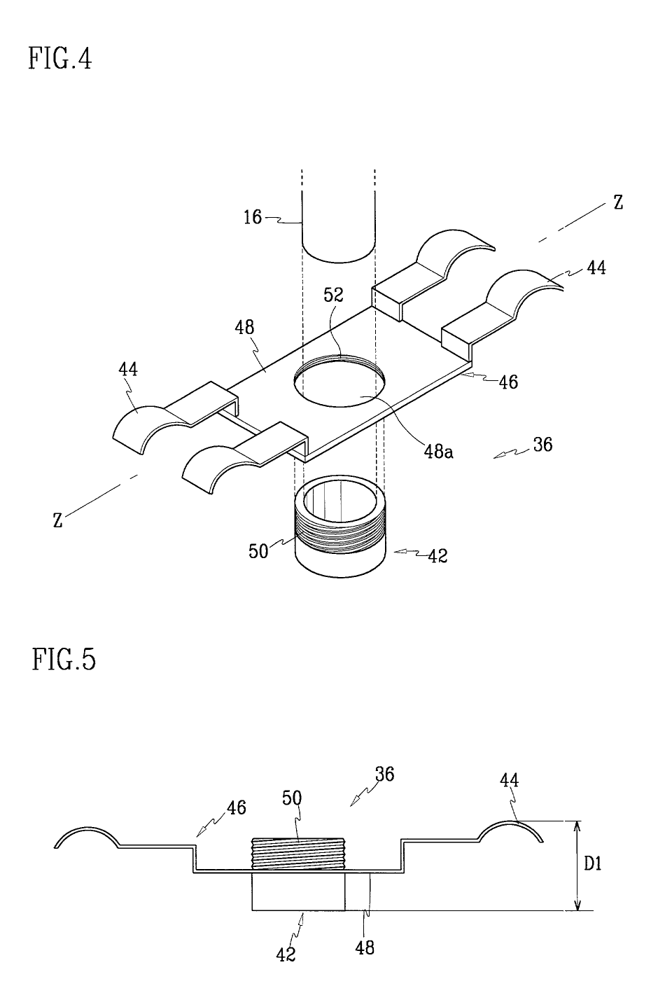

In addition, the first conductive member 36 connecting the first conductive layer 34 to the phosphor screen 10 is, as describe above, insulated from the stud pin 16. FIGS. 4 and 5 show the first conductive member 36 in greater detail.

The first conductive member 36 comprises a cylindrical insulating fixing member 42 fixedly inserted around the stud pin 16 and a conductive connecting member 46 mounted on the insulating fixing member 42 and extending in a direction of the tube-axis (the Z-axis in the drawing).

The insulating fixing member 42 is made of an insulating material such as, a ceramic to be insulated from the stud pin 16.

The conductive connecting member 46 includes a central portion 48 provided with a coupling hole 48a corresponding to the insulating fixing member 42 and a plurality of contact springs 44 extending from opposite ends of the central portion 48 in the direction of the tube-axis, the contact springs 44 contacting the metal film 28 and the first conductive layer 34 so as to electrically interconnect them.

For example, a male thread 50 is formed around a portion of an outer circumference of the insulating fixing member 42, and a female thread 52 corresponding to the male thread 50 is formed on the coupling hole 48a. Accordingly, the insulating fixing member 42 can be screw-coupled to the conductive connecting member 46.

Here, when the contact springs 44 point-contact the metal film 28 and the first conductive layer 34, the metal film 28 and the first conductive layer 34 may be damaged. To prevent this, each of the contact springs 44 is formed in a dome-shape rounded toward the metal film 28 and the first conductive layer 34 so that it can surface or line-contact the metal film 28 and the first conductive layer 34.

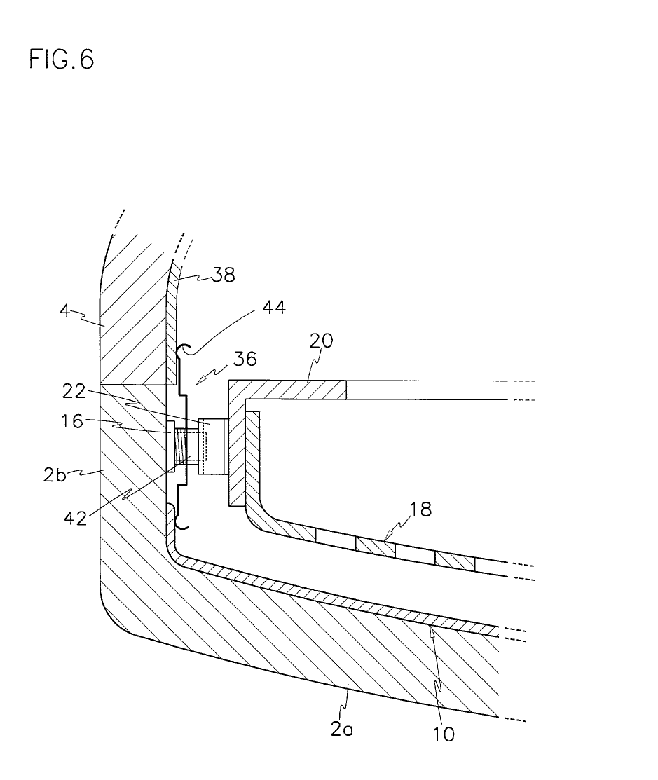

The first conductive member 36 is mounted on one of the stud pins 16 as shown in FIG. 6 before the coupling spring 22 mounted on the mask frame 20 is coupled to the stud pin 16.

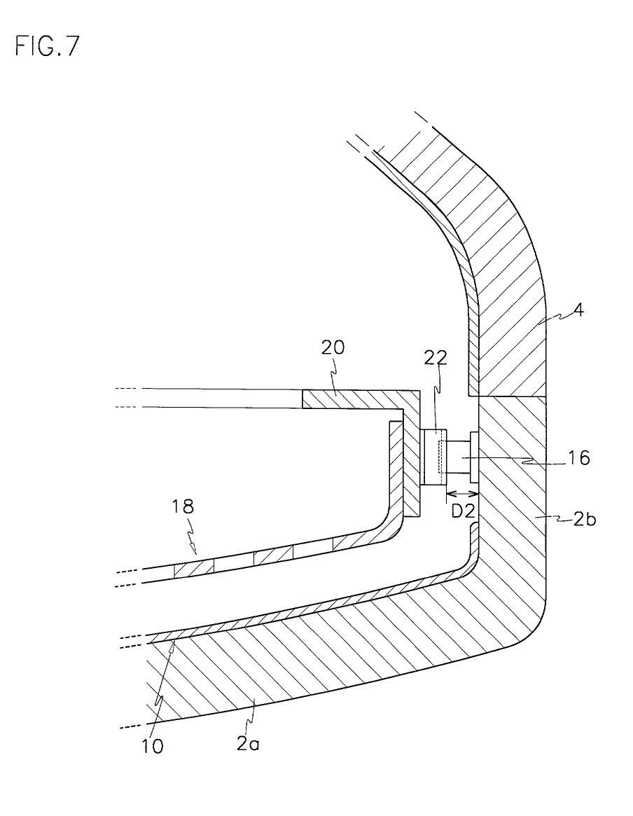

In addition, each of the contact springs 44 is elevated from the central portion 48 such that the height D1 (in FIG. 5) of the first conductive member 36 in an original (uninstalled or unbiased) state is bigger than a distance D2 (in FIG. 7) from one end of the coupling spring 22, which faces the stud pin 16, to an inner surface of the skirt portion 2b.

Accordingly, when the first conductive member 36 is mounted in the tube 8, the conductive connecting member 46 is compressed by the difference between D1 and D2. As a result, the contact spring 44 gets to securely contact the inner surfaces of the skirt portion 2b and the funnel 4.

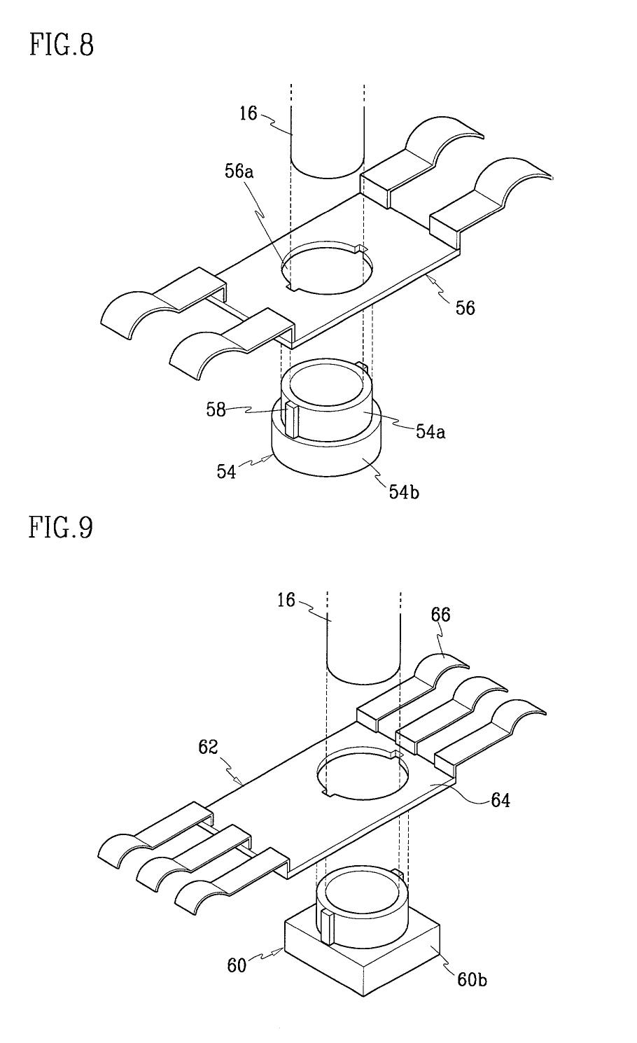

FIGS. 8 to 12 show other examples of the first conductive member according to the present invention.

Referring first to FIG. 8, when it is assumed that a portion of an insulating fixing member 54, around which a conductive connecting member 56 is inserted, is an upper portion 54a thereof, the insulating fixing member 54 is designed such that the diameter of the upper portion 54a is less than a lower portion 54b thereof.

The upper portion 54a is provided at its outer circumference with a pair of fixing projections 58. The conductive connecting member 56 is provided with a coupling hole 56a corresponding to the upper portion 54a of the insulating fixing member 54. Accordingly, the conductive connecting member 56 is securely fixed by the pair of fixing projections 58 at a border between the upper and lower portions 54a and 54b.

Referring to FIG. 9, an insulating fixing member 60 has a lower portion 60b having a square section and an upper portion identical to that shown in FIG. 8. In addition, a central portion 64 of a conductive connecting member 62 is extended to a portion where the first conductive layer 34 is located (leftward in the drawing). On each of opposite ends of the central portion 64, three contact springs 66 are formed.

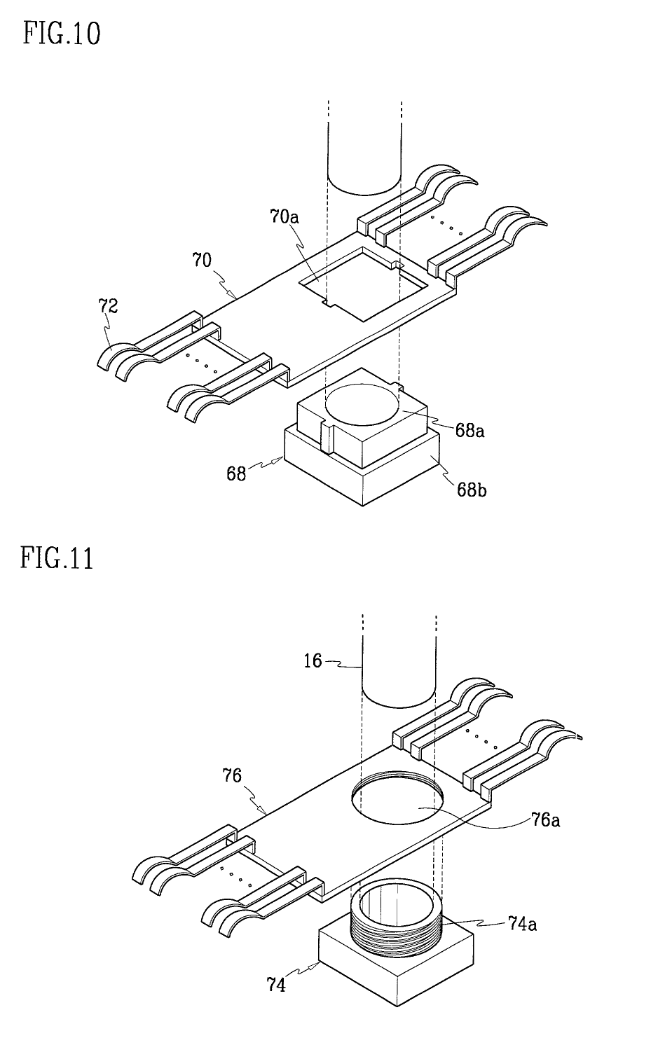

Referring to FIG. 10, upper and lower portions 68a and 68b of an insulating fixing member 68 are all formed having a square section. A coupling hole 70a of a conductive connecting member 70 is also formed in a square-shape corresponding to the upper portion 68a of the insulating fixing member 68. In addition, a plurality of contact springs 72, more than three, is formed on each side of the conductive connecting member 70.

Referring to FIG. 11, an upper portion 74a of an insulating fixing member 74 is provided with a male thread which is screw-coupled to a female thread formed in an inner circumference of a coupling hole 76a of a conductive connecting member 76.

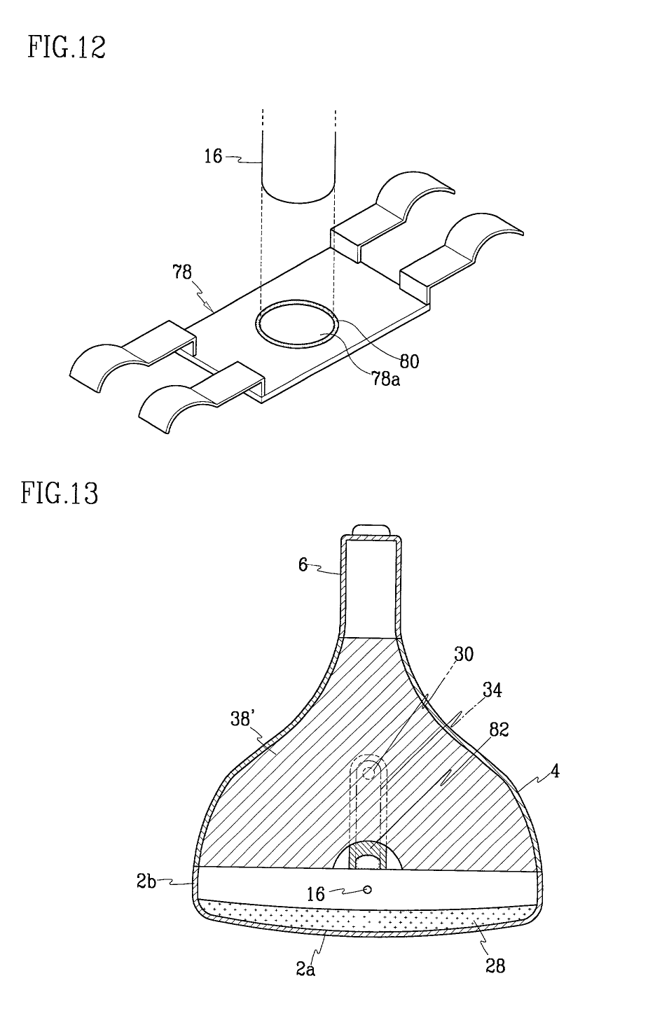

In addition, as shown in FIG. 12, instead of using the insulating fixing members described above, a packing insulating member 80 can be installed on an inner circumference of a coupling hole 78a of a conductive connecting member 78. Accordingly, the conductive connecting member 78 can be mounted around the stud pin 16 while maintaining insulation from the stud pin by the packing insulating member 80.

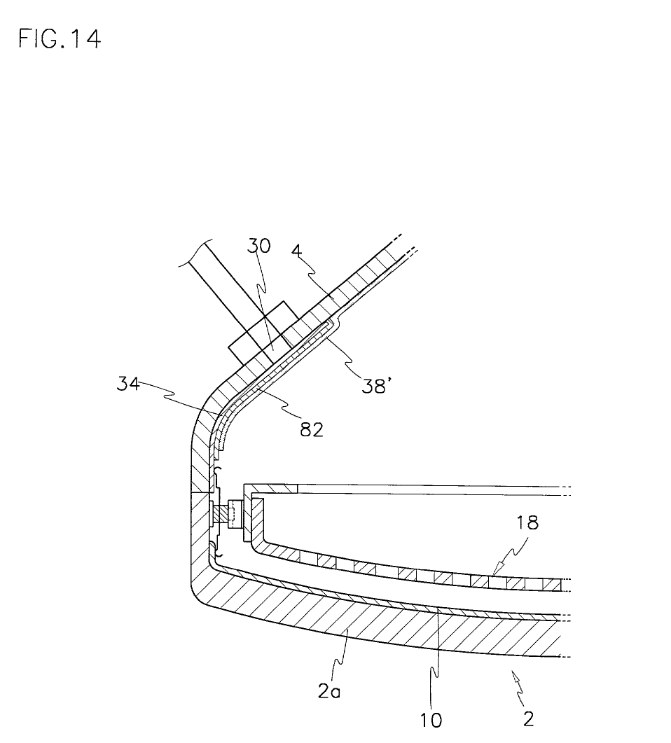

FIGS. 13 and 14 show a bi-potential mask type CRT according to another embodiment of the present invention.

As shown in the drawings, a first conductive layer 34 is covered with an insulating layer 82 except for a contact portion which contacts the first conductive member 36 (see FIG. 1). A width of the insulating layer 82 is greater than that of the first conductive layer 34. A second conductive layer 38′ is deposited on the funnel 4 while covering the insulating layer 82 except for the contact portion.

The first conductive layer 34 is made of a graphite film or aluminum, or is made of a conductive frit containing a conductive material such as silver. The insulating layer 82 is made of a non-conductive frit having a resistance of greater than a few gigaohm (GΩ), a material made by sintering glass, or a film made by applying a non-conductive coating solution then drying the same.

Accordingly, the first and second conductive layers 34 and 38′ are reliably insulated from each other by the insulating layer 82 during the operation of the CRT. In addition, even when a conductive getter layer is deposited on the inner surface of the vacuum tube 8 during the getter flashing process, since the insulation between the first and second conductive layers 34 and 38′ are uninterrupted, the different potential can be stably applied to the phosphor screen 10 and the shadow mask 18.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A bi-potential mask type cathode ray tube comprising:
a vacuum tube formed by integrally sealing a face panel, a funnel, and a neck;
a phosphor screen formed on an inner surface of the face panel, the phosphor screen including a metal film;
a plurality of stud pins mounted on an inner surface of a skirt portion of the face panel, which do not contact the metal film;
a shadow mask fixed to the stud pins by a mask frame and coupling springs, mounted on the mask frame, the shadow mask being spaced away from the phosphor screen at a predetermined distance;
first and second anode buttons separately mounted on the funnel;
a first conductive layer formed on an inner surface of the funnel and covering the first anode button;
a first conductive member mounted to one of the stud pins, to apply a screen voltage to the phosphor screen;
a second conductive layer formed on the inner surface of the funnel and covering the second anode button; and
a second conductive member having a first end fixed on the mask frame and a second end contacting the second conductive layer, to apply a mask voltage to the shadow mask.

2. The bi-potential mask type cathode ray tube of claim 1, wherein the first conductive member is insulated from the one stud pin, and has a first end contacting the first conductive layer and a second end contacting the metal film.

3. The bi-potential mask type cathode ray tube of claim 2 wherein the first conductive member further comprises:
an insulating fixing member fixedly inserted around the one stud pin; and
a conductive connecting member mounted on the insulating fixing member through a coupling hole formed on the conductive connecting member, the conductive connecting member having a plurality of contact springs electrically interconnecting the metal film and the first conductive layer.

4. The bi-potential mask type cathode ray tube of claim 3, wherein a height of the first conductive member in an uninstalled state is greater than a distance from one end of one of the coupling springs, which faces the one stud pin, to an inner surface of the skirt portion so as to bias the plurality of contact springs against the metal film and the first conductive layer.

5. The bi-potential mask type cathode ray tube of claim 3 wherein the insulating fixing member has an outer circumference with a male thread and the coupling hole of the conductive connecting member has a female thread screw-coupled to the male thread of the insulating fixing member.

6. The bi-potential mask type cathode ray tube of claim 3, wherein the insulating fixing member comprises an upper portion proximal to the one stud pin and a lower portion proximal to one of the coupling springs, a diameter of the upper portion being less than that of the lower portion so that the upper portion extends through the coupling hole of the conductive connecting member and is prevented from passing further through the coupling hole by the lower portion.

7. The bi-potential mask type cathode ray tube of claim 6 wherein the upper portion of the insulating fixing member has an outer circumference with at least one fixing projection, and the coupling hole of the conductive connecting member has a shape to receive the upper portion of the insulating fixing member including the at least one fixing projection.

8. The bi-potential mask type cathode ray tube of claim 6, wherein each of the upper and lower portions of the insulating fixing member has a circular cross section.

9. The bi-potential mask type cathode ray tube of claim 6, wherein the upper portion of the insulating fixing member has a circular cross-section and the lower portion of the insulating fixing member has a square cross-section.

10. The bi-potential mask type cathode ray tube of claim 6, wherein each of the upper and lower portions of the insulating fixing member has a square cross-section.

11. The bi-potential mask type cathode ray tube of claim 2, wherein the first conductive member further comprises a coupling hole, a packing insulating member mounted on an inner circumference of the coupling hole so as to insulate the first conductive member from the one stud pin, and a plurality of contact springs electrically connecting the metal film to the first conductive layer.

12. The bi-potential mask type cathode ray tube of claim 2, further comprising:
an insulating layer, wherein the first conductive layer is formed in a strip-shape having a predetermined width and covered by the insulating layer except for a portion contacting the first conductive member.

13. The bi-potential mask type cathode ray tube of claim 12, further comprising;
a second conductive layer deposited on the inner surface of the funnel, and covering a portion of the insulating portion except for a portion where the first conductive layer contacts the first conductive member.

14. The bi-potential mask type cathode ray tube of claim 1, wherein the metal film is a predetermined distance away from each of the stud pins.

15. The bi-potential mask type cathode ray tube of claim 1, wherein the stud pins are detachably coupled to respective ones of the coupling springs.

16. The bi-potential mask type cathode ray tube of claim 1, further comprising an insulating layer separating the first and second conductive layers from each other.

17. The bi-potential mask type cathode ray tube of claim 1, wherein the insulating fixing member is made of a ceramic.

18. The bi-potential mask type cathode ray tube of claim 3, wherein each of the contact springs has a dome-shape rounded toward the metal film and the first conductive layer.

19. The bi-potential mask type cathode ray tube of claim 3, wherein the coupling hole is shifted off-center on the conductive connecting member in a direction toward the first conductive member and away from the metal film.

20. The bi-potential mask type cathode ray tube of claim 3, wherein there are at least two of the contact springs on each of opposite sides of the conductive connecting member to contact each of the metal film and the first conductive layer.

21. The bi-potential mask type cathode ray tube of claim 20, wherein there are at least three contact springs on each of the opposite sides of the conductive connecting member.

22. The bi-potential mask type cathode ray tube of claim 21, wherein there are at least four contact springs on each of the opposite sides of the conductive connecting member, wherein the at least four contact springs form pairs having a greater distance between other ones of the pairs than between the other contact spring within the same pair.

23. The bi-potential mask type cathode ray tube of claim 1, wherein the first conductive layer is made of one of a graphite film, aluminum and a conductive frit containing a conductive material, and the insulating layer is made of one of a non-conductive frit having a resistance of at least of few gigaohms, a material made of sintering glass, and a film made by applying a non-conductive coating solution.

24. A bi-potential mask type cathode ray tube comprising:
a vacuum tube formed by integrally sealing a face panel, a funnel, and a neck;
a phosphor screen formed on an inner surface of the face panel, the phosphor screen including a metal film;
a plurality of stud pins mounted on an inner surface of a skirt portion of the face panel, and not contacting the metal film;
a shadow mask fixed to the stud pins by coupling springs mounted on a mask frame, the shadow mask being spaced away from the phosphor screen at a predetermined distance;
first and second anode buttons separately mounted on the funnel;
a first conductor having at least a portion formed on an inner surface of the funnel and covering the first anode button, the first conductor applying a screen voltage from the first anode button to the phosphor screen; and
a second conductor having at least a portion formed on the inner surface of the funnel and covering the second anode button, the second conductor a mask voltage from the second anode button to the shadow mask.

25. A bi-potential mask type cathode ray tube comprising:
a vacuum tube formed by integrally sealing a face panel, a funnel, and a neck;
a phosphor screen formed on an inner surface of the face panel, the phosphor screen including a metal film;
a plurality of stud pins mounted on an inner surface of a skirt portion of the face panel, and not contacting the metal film;
a shadow mask fixed to the stud pins by coupling springs mounted on a mask frame, the shadow mask being spaced away from the phosphor screen at a predetermined distance;
first and second anode buttons separately mounted on the funnel, wherein the first anode button provides a screen voltage and the second anode button provides a shadow mask voltage;
a first conductor contacting the first anode button;
a first conductive member having a conductive portion conducting the screen voltage from the first conductor to the metal film, and an insulating part which mounts on one of the stud pins and electrically insulates the conductive portion from the one stud pin so as to prevent the screen voltage from reaching the one stud pin and the shadow mask; and
a second conductor contacting the second anode button to conduct the mask voltage from the second anode button to the shadow mask.
